(19) United States
(12) Patent Application Publication
(10) Pub. No.: US 2021/0295279 A1
(43) Pub. Date: Sep. 23, 2021

(54) METHOD AND SYSTEM TO MANAGE DISPUTE RESOLUTION VIA DIGITAL ASSET NETWORK

(71) Applicant: MASTERCARD INTERNATIONAL INCORPORATED, Purchase, NY (US)

(72) Inventors: Sarala BURADAGUNTA, West Orange, NJ (US); Rakesh YADAV, Cape Elizabeth, ME (US)

(73) Assignee: MASTERCARD INTERNATIONAL INCORPORATED, Purchase, NY (US)

(21) Appl. No.: 17/206,883

(22) Filed: Mar. 19, 2021

Related U.S. Application Data
(60) Provisional application No. 62/992,209, filed on Mar. 20, 2020.

(51) Int. Cl. G06Q 20/02; G06Q 20/38

(52) U.S. Cl. CPC G06Q 20/02; G06Q 20/389

(57) ABSTRACT

The disclosed method includes: storing, in a memory by a processing server, a blockchain network comprised of a plurality of blocks, wherein each block is comprised of at least a block header and one or more data values, wherein the one or more data values included in a most recent block includes at least one data point associated with metrics of a financial transaction between a third-party provider and an issuer; receiving, by a receiving device of the processing server, a dispute regarding the financial transaction between the third-party provider and the issuer; retrieving, by the processing server, the metrics of the financial of the transaction between the third-party provider and the issuer; and validating, by the processing server, the metrics of the financial transaction between the third-party provider and the issuer versus expected metrics for the financial transaction.

### TECHNICAL FIELD

The present disclosure generally relates to method and system to manage dispute resolution via a digital asset network.

### BACKGROUND

Dispute resolution in open banking for both payment information service providers and account information service providers is high arduous task and typically needs manual intervention.

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. New blocks are added to the blockchain through a process known as “consensus.” In a traditional consensus process, blockchain nodes work to generate a new block that satisfies all requirements, a process known as “mining,” and then will share the new block with other nodes. The other nodes will confirm that the block is suitable and then distribute the block throughout the blockchain, which effectively adds that block into the blockchain and moves the nodes on to working on consensus on the next block.

Currently, there is a need for a technical solution whereby the power of smart contacts via a blockchain network is leveraged and brings together each of the parties to a transaction and automatically log the metrics of the transaction between, for example, a payment information service provider and an account information service provider to generate the relevant decisions in a case of a dispute, and can easily automate the dispute resolution process.

### SUMMARY

The present disclosure provides a description of exemplary systems and methods to provide a distributed ledger within a blockchain node, which can manage dispute resolution via a digital asset network.

A method is disclosed of managing dispute resolution via a digital asset network within a blockchain, the method comprising: storing, in a memory by a processing server, a blockchain network comprised of a plurality of blocks, wherein each block is comprised of at least a block header and one or more data values, wherein the one or more data values included in a most recent block includes at least one data point associated with metrics of a financial transaction between a third-party provider and an issuer; receiving, by a receiving device of the processing server, a dispute regarding the financial transaction between the third-party provider and the issuer; retrieving, by the processing server, the metrics of the financial of the transaction between the third-party provider and the issuer; and validating, by the processing server, the metrics of the financial transaction between the third-party provider and the issuer versus expected metrics for the financial transaction.

A system is disclosed for managing dispute resolution via a digital asset network within a blockchain, the system comprising: a processing server configured to: store in a memory, a blockchain network comprised of a plurality of blocks, wherein each block is comprised of at least a block header and one or more data values, wherein the one or more data values included in a most recent block includes at least one data point associated with metrics of a financial transaction between a third-party provider and an issuer; receive a dispute regarding the financial transaction between the third-party provider and the issuer; retrieve the metrics of the financial of the transaction between the third-party provider and the issuer; and validate the metrics of the financial transaction between the third-party provider and the issuer versus expected metrics for the financial transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for managing dispute resolution via digital asset network within a blockchain network in accordance with exemplary embodiments.

FIG. 2 is a block diagram illustrating a processing server of the system of FIG. 1 for managing dispute resolution via digital asset network within a blockchain network in accordance with exemplary embodiments.

FIG. 3 is a flow diagram illustrating a process for managing dispute resolution via digital asset network within a blockchain network in the system of FIG. 1 in accordance with an exemplary embodiment.

FIG. 4 is a flow diagram illustrating an exemplary method for managing dispute resolution via digital asset network within a blockchain network in accordance with another exemplary embodiment.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency or network. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

### System for Providing a Service Node Using a Blockchain Network

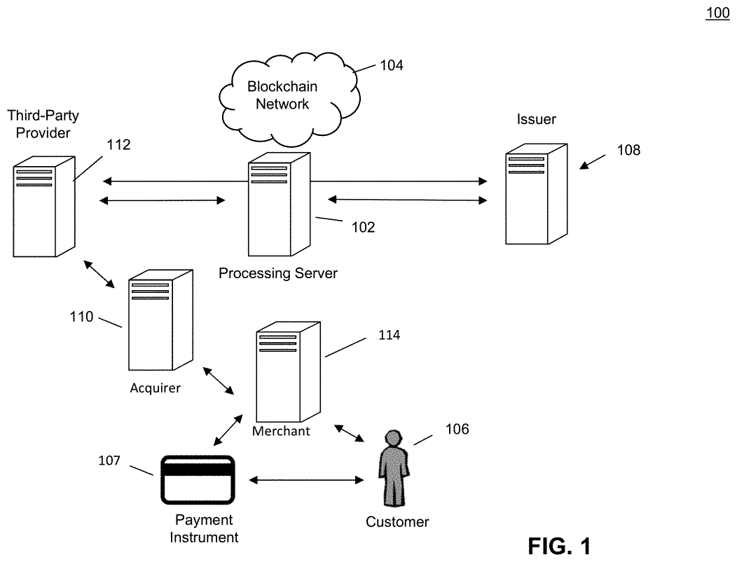

FIG. 1 illustrates a system 100 for providing a service node within a blockchain network.

The system 100 may include a processing server 102. The processing server 102 may be one of a plurality of nodes or processors comprising a blockchain network 104. The blockchain network 104 may be associated with one or more blockchains, which may be used to store data associated with dispute resolution via a digital asset network, for example, between an issuer 108 and a third-party provider 112. In accordance with an embodiment, the third-party provider 112 provide services, for example, to a user, for example, the issuer (e.g., issuing institutions) 108 or an acquirer 110. The processing server 102 (for example, a central node) may be configured to generate and validate new blocks that are added to the blockchain, where the validation process for a new block may involve mathematical verification of data stored therein across a plurality of the nodes comprising the blockchain network 104.

In the system 100, for example, a customer 106 may purchase a service or product from one or merchants 114 or other entities with, for example, a payment instrument 107. As referred to herein, a “merchant” may refer to any entity that provides products (e.g., goods and/or services) for purchase by another entity, such as a consumer 106 or another merchant 114.

In an embodiment, the system 100 may include one or more issuers 108 (i.e., issuing institutions). The issuer 108 may be a financial institution, such as an issuing bank, or other suitable entity that is configured to issue a transaction account to the customer 106 for use in funding payment transactions. The issuer 108, for example, issuer or issuing institution may issue a transaction account to the customer 106 and, as part of the issuing of the transaction account, may issue a payment instrument 107 to the customer 106. The payment instrument 107 may be, for instance, a credit card, virtual payment card, check, electronic wallet, etc. The payment instrument 107 may be encoded with, include, or be otherwise associated with payment credentials corresponding to a transaction account. The payment credentials may include any data that must be communicate as part of a transaction process for the transaction to be funded via the related transaction account, such as a primary account number, expiration date, and security code.

In accordance with an embodiment, the blockchain network 104 may be comprised of a plurality of blocks, where each block is comprised of a block header and one or more data values. The data values may each be associated with services provided by the third-party provider 112 and/or issuer 108, and may include, for example, services directed to country validations and/or smart contacts as disclosed herein. Each block header may include at least a timestamp, a block reference value, and a data reference value. The timestamp may be a stamp of a time when the block header is generated. The block reference value may be a reference to the previous block (e.g., determined via timestamp) in the blockchain. In some cases, the block reference value may be a hash value generated via the application of one or more hashing algorithms to the block header of the previous block. The data reference value may be a reference to the one or more data values included in the respective block. In some cases, the data reference value may be a hash value generated via the application of one or more hashing algorithms, which may be the same or different than those used in generation of the block reference value, to the one or more data values included in the block. The use of the reference values may ensure that the data stored in the blockchain is immutable, as a modification to any data value can be detected via generation of the data reference value, as it would thus differ from the value stored in the block header, which would, in turn result in a different block reference value for the subsequent block, which would carry on through every subsequent block. As a result, no block header or data value may be modified without requiring modification to every single subsequent block in the blockchain. As each node in the blockchain network 104 may store the blockchain, no modification to the blockchain may be performed without compromise of every single node.

In accordance with an embodiment, the processing server 102 of the blockchain network 104 may receive the data value corresponding to transactions between, for example, a third-party provider 112, the processing server 102, and the issuer 108, which may be included in a newly generated block (e.g., and incorporated into the data reference value in the respective block header). The generated block may be validated by other nodes in the blockchain network 104 using traditional methods, which may include independent generation of the reference values and validation thereof. Once validation is completed, the newly generated block may be added to the blockchain and provisioned to all of the nodes in the blockchain network 104. In some embodiments, validation of the data prior to addition of the new block may include authentication of the issuer 108 and/or the third-party provider 112. In some instances, authentication may be performed via a password or other unique value(s) provided by the issuer 108 and/or the third-party provider 112 for authentication thereof. In other instances, the blockchain network 104 may provision a private key to the issuer 108 and/or the third-party provider 112 of a cryptographic key pair. In such an instance, the issuer 108 and/or the third-party provider 112 may generate a digital signature using their private key, which may be submitted to the processing server 102 with their services provided. In these instances, the processing server 102 may validate the digital signature using the corresponding public key and associated signature validation algorithms to authenticate the issuer 108 and/or the third-party provider 112. In some cases, the other nodes comprising the blockchain network 104 may also validate the digital signature as part of the validation process before confirming a new block for addition to the blockchain.

In accordance with an exemplary embodiment, the issuer 108 and/or the third-party provider 112 can join with the processing server 102 associated with a payment network, to form a network for managing dispute resolution. In accordance with an exemplary embodiment, the processing server 102 using, for example, a blockchain network 104, can be generate an immutable record of all transactions between issuer 108 and/or the third-party provider 112 as the transaction happens and which is automatically recorded in the blockchain network 104. The transactional information can be signed by any two (2) of the three (3) parties to the transaction, e.g., the issuer 108 (i.e., bank), the third-party provider 112, and the processing server 102 (i.e., payment network).

In accordance with an exemplary embodiment, for example, the data associated with an account information service (AIS) can be latency, authorization, access, and/or API grant access. For a payment information service (PIS), the data can be payment information, for example, amount and receiver information. In accordance with an embodiment, the process preferably involves no manual intervention and ideally tamper proof. Relevant smart contracts can be set in place to track and trigger relevant scenarios and metrics. In addition, when a smart contract is triggered, the processing server 102 (i.e., payment network) can have enough information to act as an arbitrator and relay a decision without any manual intervention, for example, using machine learning or artificial intelligence applications. Additionally, when a dispute is raised, for example, by the issuer 108 and/or the third-party provider 112, the processing server 102 (i.e., payment network) has the ability to look at the transaction data as it happened, provide a proof of such validation, arbitrate and relay a decision to the party, for example, the issuer 108 and/or the third-party provider 112.

### Processing Server

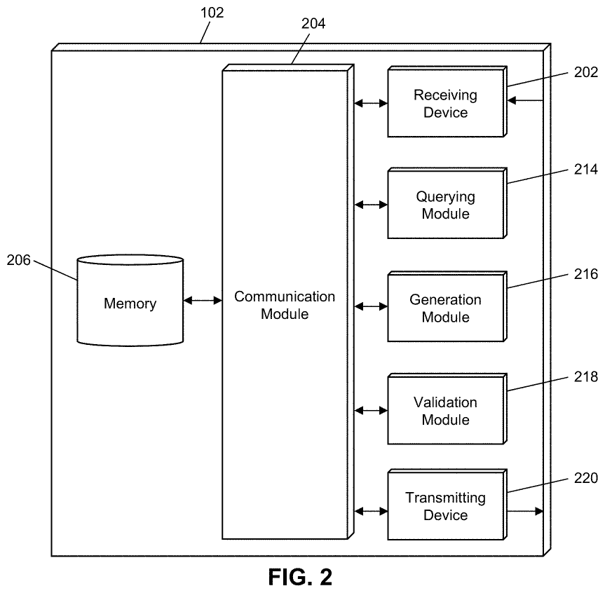

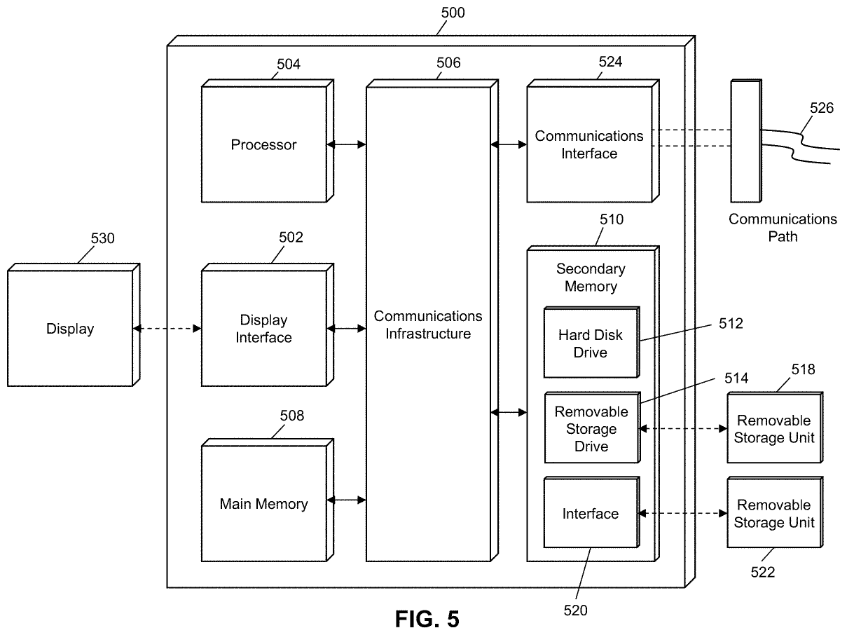

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from issuer 108, third-party provider 112, other nodes in the blockchain network 104, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by a third-party provider 112 and/or issuer 108. In accordance with an exemplary embodiment, the data signals electronically transmitted can be relevant metrics of requests, for example, latency, throughput, and up-times to help manage dispute resolution via the digital asset network. In accordance with an embodiment, the relevant metrics can be agreed upon by the customer or user 106 and issuer 108 according to a contract and/or rules based upon the payment instrument 107. The receiving device 202 may also be configured to receive data signals electronically transmitted by other nodes in the blockchain network 104 and/or third-party provider 112, as applicable.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, validation module 218, etc. As used herein, the term “module” may be software executed on hardware or hardware particularly programmed to receive an input, perform one or more processes using the input, and provides an output. The input, output, and processes performed by various modules will be apparent to one skilled in the art based upon the present disclosure.

The processing server 102 may include a memory 206. The memory 206 may be configured to store data for use by the processing server 102 in performing the functions discussed herein, such as public and private keys, symmetric keys, etc. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein.

The memory 206 may be configured to store a blockchain. As discussed above, the blockchain may be comprised of a plurality of blocks, where each block may be comprised of at least a block header and one or more data values. Each block header may include a time stamp, a block reference value referring to the preceding block in the blockchain, and a data reference value referring to the one or more data values included in the respective block. The memory may also be configured to store any additional data that may be used by the processing server 102 in performing the functions discussed herein, such as hashing algorithms for generating reference values for the blockchain, communication data for communicating with other blockchain nodes and other computing devices, access data for providing access to third-party provider 112 to blockchain data, public keys corresponding to private keys provisioned to issuer 108 for verification of digital signatures, etc.

The processing server 102 may include a querying module 214. The querying module 214 may be configured to execute queries on databases to identify information. The querying module 214 may receive one or more data values or query strings and may execute a query string based thereon on an indicated database, such as the memory 206, to identify information stored therein. The querying module 214 may then output the identified information to an appropriate engine or module of the processing server 102 as necessary. The querying module 214 may, for example, execute a query on the memory 206 to identify a the most recent block added to the blockchain (e.g., based on timestamp) as part of the process in generating a new block, or may execute a query on the memory 206 to identify a public key corresponding to the issuer 108 for use in validating a digital signature provided with data associated with the type of services or functions provided by the issuer 108 for authentication thereof.

The processing server 102 may also include a generation module 216. The generation module 216 may be configured to generate data for the processing server 102 for use in performing the functions discussed herein. The generation module 216 may receive instructions as input, may generate data based on the instructions, and may output the generated data to one or more modules or engines of the processing server 102. For example, the generation module 216 may be configured to generate new blocks and new block headers for confirmation and addition into the blockchain. The generation module 216 may also be configured to generate hash values via the application of hashing algorithms to data, such as for the generation of reference values to be included in the block header of a newly generated block. In some cases, the generation of hash values may be performed via a separate hashing module included in the processing server 102.

The processing server 102 may also include a validation module 218. The validation module 218 may be configured to validate data for the processing server 102 and the issuer 108 for use in performing the functions discussed herein. The validation module 218 may receive instructions as input, may validate data as instructed, and may output a result of the validation to another module or engine of the processing server 102.

The processing server 102 may also include a transmitting device 220. The transmitting device 220 may be configured to transmit data over one or more networks via one or more network protocols. In some instances, the transmitting device 220 may be configured to transmit data to the issuer 108 in the blockchain network 120, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to other nodes in the blockchain network 120, including issuer 108, as applicable, that are superimposed or otherwise encoded with newly generated blocks for validation and confirmation thereof. The transmitting device 220 may also be configured to electronically transmit data signals superimposed or otherwise encoded with confirmed blocks to the issuer 108 for the updating of data associated with the type of services or functions provided by the issuer 108. In some instances, the transmitting device 220 may be configured to electronically transmit data signals to issuer 108, which may be superimposed or otherwise encoded with notifications regarding the updating of data associated with the type of services or functions provided by the issuer 108 (e.g., the successful generation of a new block, etc.). In some embodiments, the transmitting device 220 may be configured to electronically transmit data signals to the issuer 108 for the provisioning of a cryptographic key pair thereto for use in generating digital signatures for use during submissions of data associated with the type of services or functions provided by the issuer 108.

### Process for Managing Dispute Resolution

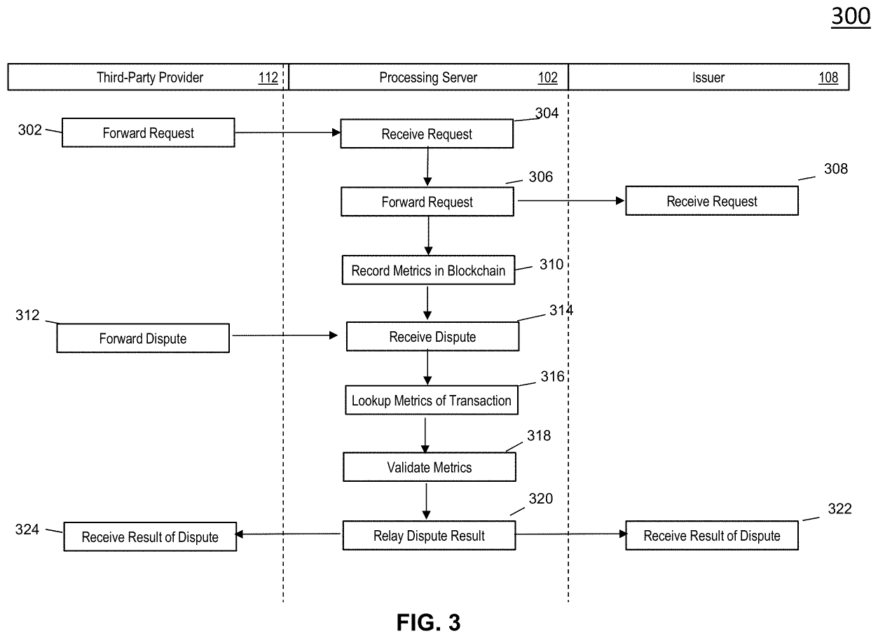

FIG. 3 is a flow diagram 300 illustrating a process for managing dispute resolution via digital asset network within a blockchain network in the system of FIG. 1 in accordance with exemplary embodiments. As shown in FIG. 3, in step 302, the third-party provider forwards a request, for example, a request for a financial transaction, to the issuer 108, which is received by the processing server 102 (i.e., payment network) in step 304. In accordance with an embodiment, the processing server 102 has the capability to record all of the relevant metrics of the request, for example, the latency (i.e., delay before a transfer of data begins following an instruction for its transfer), the throughput (i.e., amount of data and/or rate which the data is processed), and up-times (i.e., period of times in which computers or processing servers associated with the issuer 108 and the third-party provider 112, for example, are functioning). In accordance with an embodiment, the issuer 108 and the third-party provider 112 can define and agree upon the contract and/or rules for these metrics. In step 306, the request for the financial transaction is forwarded to the issuer 108 by the processing server 102 and received by the issuer 108 in step 308.

In step 310, all of the metrics that are relevant to an API request like latency, throughput, and up-times received by the processing server 102 are recorded in the blockchain network 104. In accordance with an embodiment, smart contracts can be leveraged to enable this recording capacity. For example, the recording in the blockchain network of the metrics can include inserting the metrics (or metric data) onto a blockchain and during the insertion and after a block has been confirmed, the entry hash and block number can be saved in a database by the processing server 102 outside of the blockchain. In addition, an injection reference of the hashed data can be returned by the processing server 102 to the issuer 108 and/or third-party provider 112.

In step 312, a dispute may be sent by the third-party provider 112, which is received by the processing server 102 in step 314. In accordance with embodiment, the processing server 102 will act as the arbitrator. In step 316, the processing server 102 looks up the transactional information (i.e., the metrics of the transaction) that was recorded in the blockchain network 104 and validates the transactional information against the expected metrics in step 318 in order to arbitrate the dispute. In accordance with an exemplary embodiment, in the event of a dispute, for example, the injection reference of the hash data that was returned to the issuer 108 and/or third-party provider 112 during the insertion of the metrics onto the blockchain can be used to query the blockchain. The processing server 102 can then retrieve, for example, the block number, time when the block was created, signature of the block, Merkle path, and the Merkle root pertaining to the hash entry. In addition, for example, the smart contracts can be leveraged to validate the metrics in step 318.

In step 320 the processing server 102 relays the dispute result to the issuer 108 and/or the third-party provider 112, which are received by the issuer 108 and the third-party provider 112 in steps 322, 324, respectively.

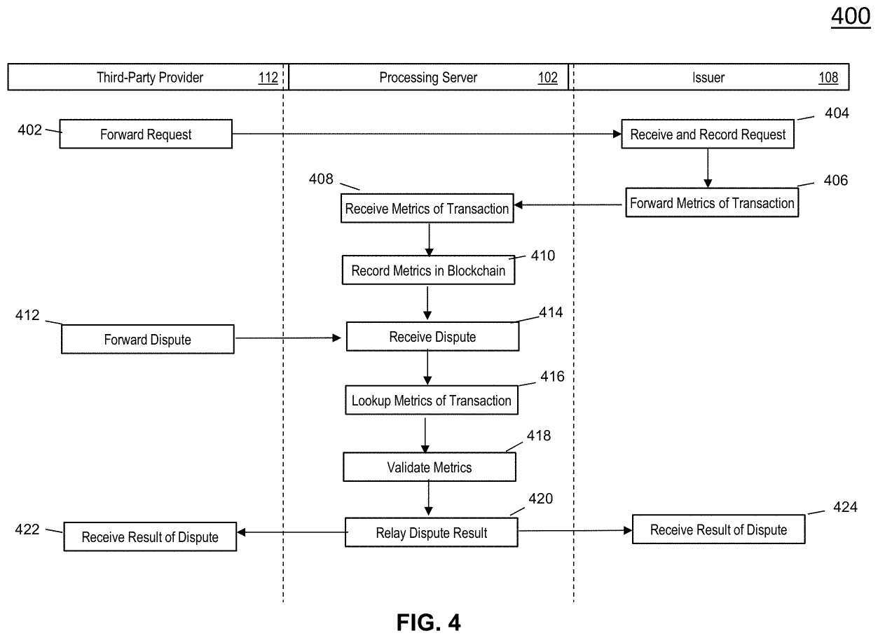

FIG. 4 is a flow diagram 400 illustrating an exemplary method for managing dispute resolution via digital asset network within a blockchain network in accordance with another exemplary embodiment. In the embodiment as shown in FIG. 4, the issuer 108 is external to the processing server 102 (i.e., payment network) such that in step 402, the request from third-party provider 112 is sent directly to the issuer 108. In step 404, the issuer 108 receives and records the request and then in step 406, the issuer 108 submits (or forwards) the relevant network metrics via an API to the processing server 102. In accordance with an embodiment, in step 408, the relevant network metrics are signed by both the user and bank nodes, for example, the issuer (i.e., bank) 108 and the third-party provider 112. In step 408, all of the metrics that are relevant to an API request, for example, latency, throughput, and up-times are received by the processing server 102, and in step 410 are recorded in the blockchain network 104. In accordance with an exemplary embodiment, smart contracts can be leveraged to enable the obtaining of the relevant metrics. In the case of dispute initiated in step 412, for example, between the third-party provider 112 and the issuer 108 by the third-party provider 112, and received in step 414, by the processing server 102 (i.e., payment network), the processing server 102 acts as the arbitrator. In step 416, the processing server 102 (i.e., payment network) looks up the transactional information that was recorded in the blockchain network 104 and in step 418, the processing server 102 validates the transactional information against the expected metrics, which can including leveraging the smart contracts to validated the metrics of the transaction in order to arbitrate the dispute. In step 420, the processing server 102, relays the dispute result to the third-party provider 112 and/or the issuer 108, which are received by the third-party provider 112 and the issuer 108, in steps 422 and 424, respectively.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general-purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for managing dispute resolution via a digital asset network. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method of managing dispute resolution via a digital asset network within a blockchain, the method comprising:
storing, in a memory by a processing server, a blockchain network comprised of a plurality of blocks, wherein each block is comprised of at least a block header and one or more data values, wherein the one or more data values included in a most recent block includes at least one data point associated with metrics of a financial transaction between a third-party provider and an issuer;
receiving, by a receiving device of the processing server, a dispute regarding the financial transaction between the third-party provider and the issuer;
retrieving, by the processing server, the metrics of the financial transaction between the third-party provider and the issuer; and
validating, by the processing server, the metrics of the financial transaction between the third-party provider and the issuer versus expected metrics for the financial transaction.

2. The method according to claim 1, comprising:
relaying, by the processing server, a result of the validation of the metrics of the financial transaction between the third-party provider and the issuer versus the expected metrics for the financial transaction.

3. The method according to claim 1, comprising:
leveraging, by the processing server, smart contracts to enable recording of the metrics of the financial transaction between the third-party provider and the issuer.

4. The method according to claim 1, wherein the processing server is an arbitrator of the dispute between the third-party provider and the issuer regarding the financial transaction.

5. The method according to claim 1, wherein the metrics are one or more of latency, throughput, and up-times.

6. The method according to claim 1, wherein the metrics are one or more of latency, authorization, access, API grant access, and/or payment information, the payment information including amount and/or receiver information.

7. The method according to claim 1, comprising:
relaying, by the processing server, a result of the validation of the metrics of the financial transaction between the third-party provider and the issuer versus the expected metrics for the financial transaction without any manual intervention.

8. A system for managing dispute resolution via a digital asset network within a blockchain, the system comprising:
a processing server configured to:
store in a memory, a blockchain network comprised of a plurality of blocks, wherein each block is comprised of at least a block header and one or more data values, wherein the one or more data values included in a most recent block includes at least one data point associated with metrics of a financial transaction between a third-party provider and an issuer;
receive a dispute regarding the financial transaction between the third-party provider and the issuer;
retrieve the metrics of the financial of the transaction between the third-party provider and the issuer; and
validate the metrics of the financial transaction between the third-party provider and the issuer versus expected metrics for the financial transaction.

9. The system according to claim 8, wherein the processing server is configured to:
relay a result of the validation of the metrics of the financial transaction between the third-party provider and the issuer versus the expected metrics.

10. The system according to claim 8, wherein the processing server is configured to:
leverage smart contracts to enable recording of the metrics of the financial transaction between the third-party provider and the issuer.

11. The system according to claim 8, wherein the processing server is an arbitrator of the dispute between the third-party provider and the issuer regarding the financial transaction.

12. The system according to claim 8, wherein the metrics are one or more of latency, throughput, and up-times.

13. The system according to claim 8, wherein the metrics are one or more of latency, authorization, access, API grant access, and/or payment information, the payment information including amount and/or receiver information.

14. The system according to claim 8, wherein the processing server is configured to:
relay a result of the validation of the metrics of the financial transaction between the third-party provider and the issuer versus the expected metrics for the financial transaction without any manual intervention.
